(19) United States
(12) Patent Application Publication
(10) Pub. No.: US 2008/0020269 A1
(43) Pub. Date: Jan. 24, 2008

(54) Filling plug for battery cells

(75) Inventor: Klaus Scherzer, Dachau (DE)

Correspondence Address: COHEN, PONTANI, LIEBERMAN & PAVANE, 551 FIFTH AVENUE, SUITE 1210, NEW YORK, NY, 10176, US

(73) Assignee: Elke OSCHMANN, Bergkirchen (DE)

(21) Appl. No.: 11/488,289

(22) Filed: Jul. 18, 2006

(51) Int. Cl. H01M 2/36

(52) U.S. Cl. 429/74

(57) ABSTRACT

A filling plug for battery cells includes a cylindrical housing, a valve system contained in the housing and connected to at least two horizontally protruding feeding tubes. Further, the filling plug includes a float partially projecting downward from the lower portion of the housing for actuating the valve system, and an axially extending tubular snap ring element which is to be inserted into and fastened in a filling opening of the battery cell. The snap ring element has bayonet coupling elements at an outer wall.

### BACKGROUND OF THE INVENTION

1. Field of the Invention

The invention relates to a filling plug for battery cells comprising a cylindrical housing containing a float for actuating a valve system positioned in the housing and connected to at least two feeding tubes horizontally protruding from an upper portion of the housing, wherein the housing has at its lower portion connection means to be inserted into and fastened in a filling opening of the battery cell.

2. Description of the Related Art

It is known that accumulator batteries, particularly powerful batteries, during their operation lose part of the distilled water in the sulfuric acid solution. This means that it is necessary to continuously add water in order to prevent the lowering of the electrolyte level from causing a deterioration of the accumulator together with a lowering of its energy performance.

For this reason, systems for the automatic refilling of distilled water into the battery cells become more and more popular. In these systems a feeding tank is connected by means of pipes to filling plugs, each of which is inserted into the filling opening of the cell. In batteries the cells are interconnected in series, and consequently the feeding tubes protruding as a T-piece from the outer part of the housing of each plug are interconnected with the feeding tubes of the adjacent filling plugs by hoses. When, by means of the refilling, the necessary level of electrolyte has been reached in each cell, the corresponding float shuts the valve in each plug.

In known types of accumulators made up of a series of battery cells, each cell has an upper filling opening in the form of a circular hole, which has one or more diametrically opposed radially inward protruding ledges, such that a radial shoulder of a bayonet coupling element provided at the lower portion of the plug housing may be inserted into the filling opening. In order to securely fix the filling plug after insertion into the opening, the plug housing has to be rotated by a certain angle, typically 90°. Only after the last mentioned fixing step of the filling plugs, the feeding tubes can be interconnected by the hoses.

### SUMMARY OF THE INVENTION

It is an object of the invention to provide a filling plug for battery cells, the feeding tubes of which may be interconnected by the above mentioned hoses before mounting the plugs into the battery openings.

Therefore, a filling plug for battery cells of the type described above is proposed, wherein the connection means is made up of an axially extending tubular snap ring element provided at its outer wall with bayonet coupling elements.

According to the invention, a series of filling plugs may be preassembled by interconnecting their feeding tubes through hoses typically having a short length. Later on, such premounted series of filling plugs, called kits, may be inserted into the filling openings of the accumulator cells. To this end, there is no need to rotate the filling plugs in order to insert the bayonet coupling elements in the correct angular position into the filling openings. The plugs will be mounted into the filling openings by simply pressing them into said openings. During this operation, each axially extending tubular ring element will snap into the filling opening. If it becomes necessary to remove the filling plugs, the hoses have to be detached from the feeding tubes whereafter each filling plug may be rotated by a quarter turn such that the bayonet coupling element can be axially extracted from the respective filling opening.

In a further embodiment of the invention, each snap ring element is provided with at least one axially extending slit allowing a radially elastic contraction of the snap ring element.

In a preferred embodiment, each of said bayonet coupling elements comprises a circumferentially limited shoulder radially projecting from the outer wall of an adapter sleeve, which is fastened to the lower end of the plug housing, and having a downward sloping surface to facilitate insertion into the filling opening.. This has the further advantage that different types of filling plugs may be connected to the filling openings, regardless the type of the fixing means at the lower end of the plug housing.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

The invention is described below with reference to an example shown in the drawings in which

FIG. 1 is a schematic top view of a series of battery cells of a heavy duty accumulator,

FIG. 2 is a perspective view of a filling plug according to the invention,

FIG. 3 is a cross sectional view of an adapter sleeve to be fastened to the lower end of the housing of the filling plug, and

FIG. 4 is a bottom view of the adapter sleeve of FIG. 3.

### DETAILED DESCRIPTION OF THE PRESENTLY PREFERRED EMBODIMENTS

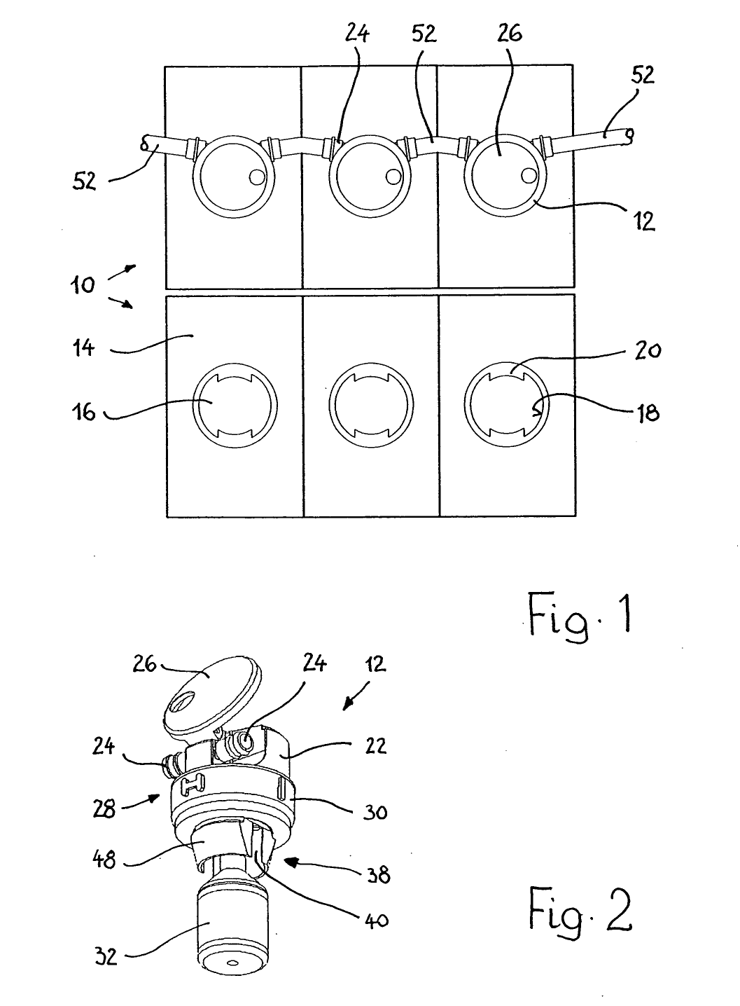

FIG. 1 shows the top view of an accumulator 10 during the mounting phase of a series of interconnected filling plugs 12. The upper horizontal wall 14 of the accumulator 10 is provided with filling openings 16 each of which is made up of a circular hole 18 which has two diametrically opposed ledges 20 protruding radially inward.

As illustrated in FIG. 2, each filling plug 12 comprises a cylindrical housing 22. In a manner known per se and not illustrated, each plug 12 contains a float 32 for actuating a valve system positioned in said plug housing 22 and connected to two feeding tubes 24 horizontally protruding as a T-piece from an upper portion of the housing 22 which is closed by a lid 26.

The housing 22 is provided at its lower end 28 with an adapter sleeve 30 fastened to that lower end 28 by fastening elements which correspond to fastening elements provided at said lower end 28, e.g. a thread, a snap fastener or a bayonet fastener.

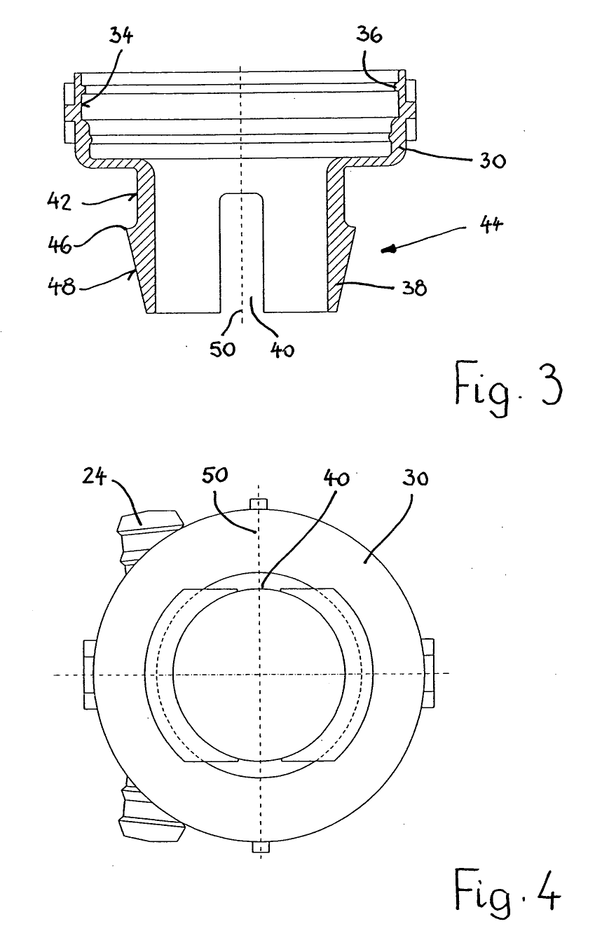

In the example of FIGS. 3 and 4, the adapter sleeve 30 is provided at its inner wall 34 with radially inward extending annular protrusions 36 for engaging annular grooves provided at the lower end 28 of the housing 22, such that the adapter sleeve 30 may be turned by 360° on said lower end 28 of the housing 22.

The lower end of the adapter sleeve 30 is in the form of an axially extending tubular snap ring element 38 which is provided with two axially extending slits 40 allowing a radially elastic contraction of the snap ring element 38.

The tubular snap ring element 38 is further provided at its outer wall 42 with bayonet coupling elements 44 each of which is made up of a shoulder 46 radially projecting from that outer wall 42. These shoulders preferably have a circumferentially limited extent. Each shoulder 46 has a downward sloping surface 48 to facilitate insertion into the filling opening 16 of the corresponding battery cell.

In the configuration of the filling openings 16 of FIG. 1, in which their radially inward protruding ledges 20 are parallel to each other, care should be taken to have the right position of the adapter sleeve 30 at the lower end 28 of the housing 22, i.e., as depicted in FIG. 4, the two feeding tubes 24 should be parallel to the plane 50 connecting both slits 40.

In the upper part of FIG. 1, the kit made up of a series of interconnected filling plugs 12 is shown in which each pair of adjacent feeding tubes 24 is connected by a short hose 52. Such premounted series of filling plugs 12 is then mounted into the filling openings 16, simply by pressing the lower ends 28 or the adapter sleeve 30, respectively, of each filling plug 12 into the corresponding filling opening 16. In this way, the tubular snap ring element 38 will be elastically contracted in the radial direction whereupon, at the end of the insertion, the shoulders 46 of the bayonet coupling element 44 will click behind the ledges 18 of each opening 16. If it is necessary to dismount the filling plugs 12, the connecting hoses 52 will have to be pulled off the feeding tubes 24 whereon each filling plug 12 may be rotated by 90° such that the shoulders 46 of each bayonet coupling element 44 may be drawn out through the hole 18 of each cell.

The invention is not limited by the embodiments described above which are presented as examples only but can be modified in various ways within the scope of protection defined by the appended patent claims.

I claim:

1. A filling plug for battery cells comprising:
a cylindrical housing having an upper portion and a lower portion;
a valve system contained in said housing;
at least two feeding tubes connected to said valve system and protruding horizontally from said upper portion of said housing;
a actuating said valve system; and float partially projecting downward from said lower portion of said housing for
an axially extending tubular snap ring element to be inserted into and fastened in a filling opening of the battery cell, said snap ring element having bayonet coupling elements at an outer wall.

2. The filling plug of claim 1, wherein said snap ring element has at least one axially extending slit allowing a radially elastic contraction of said snap ring element.

3. The filling plug of claim 1, wherein each of said bayonet coupling elements comprises a circumferentially limited shoulder radially projecting from said outer wall and having a downward sloping surface to facilitate insertion into the filling opening of the battery cell.

4. The filling plug of claim 1, wherein said axially extending tubular snap ring element is an adapter sleeve fastened to said lower portion of said housing.

5. The filling plug of claim 4, wherein said adapter sleeve is rotatably mounted on said lower portion of said housing.

6. The filling plug of claim 1, wherein said feeding tubes form the upper parts of a T-piece, thus protruding coaxially in opposite directions.

7. A filling plug assembly with
a plurality of filling plugs for battery cells, each of the filling plugs comprising a cylindrical housing having an upper portion and a lower portion;
a valve system contained in said housing;
at least two feeding tubes connected to said valve system and protruding horizontally from said upper portion of said housing;
a float partially projecting downward from said lower portion of said housing for actuating said valve system; and
an axially extending tubular snap ring element to be inserted into and fastened in a filling opening of the battery cell, said snap ring element having bayonet coupling elements at an outer wall; and with
hoses for connecting respective feeding tubes of adjacent filling plugs.
